(19) United States
(12) Patent Application Publication
(10) Pub. No.: US 2016/0257153 A1
(43) Pub. Date: Sep. 8, 2016

(54) A PRINTABLE MEDIA WITH SELF ADHERING PRINTABLE COMPOSITIONS

(71) Applicant: 3M INNOVATIVE PROPERTIES COMPANY, St. Paul, MN (US)

(72) Inventors: Abhik Pal, Bangalore (IN); Aniket Panda, New Delhi (IN); Jeffrey O. Emslander, Stillwater, MN (US); Sachin Talwar, Woodbury, MN (US)

(21) Appl. No.: 15/030,752

(22) PCT Filed: Oct. 21, 2014
(86) PCT No.: PCT/US2014/061512

§ 371 Date: Apr. 20, 2016

(30) Foreign Application Priority Data
Oct. 22, 2013 (IN) 4759/CHE/2013

(51) Int. Cl. B41M 5/52; B05D 7/04

(52) U.S. Cl. CPC B41M 5/52; B05D 7/04

(57) ABSTRACT

The present invention relates to a printable media containing a self adhering printable compositions for digital printing and prepared by coating of the self adhering printable composition on an untreated nonwoven substrate. The printable medium of the present invention has excellent ink receptivity (printability) on a variety of ink-jet and other printing platforms and is ideally suited to be used as signage banners, commercial hoardings etc.

### FIELD OF THE INVENTION

The present invention relates to a printable media containing self adhering printable compositions for digital printing and a process for its preparation by coating of the self adhering printable composition on an untreated nonwoven substrate. The printable medium of the present invention has excellent ink receptivity on a variety of ink-jet and other printing platforms and is ideally suited for signage banners, commercial hoardings, branding and decoration for retail outlets, canvas, wallpaper for homes and offices or related other indoor and outdoor applications for short to long term service life.

### BACKGROUND OF THE INVENTION

Outdoor and indoor banners or signage are a fast growing market segment, especially in emerging markets. For example, In India, the digital printing market forms an overwhelming majority of the signage market. As of 2012, the market size was close to $150 M with market growth rate in excess of 25%. Also, a huge 94% of this market operates in Tier C category with a price point of less than $1.6 per sq m. Out of this, 40% market share is commanded by adhesive backed vinyls and majority 60% by non adhesive nonlit/frontlit and backlit banners.

Typical printing media available in the market comprise of two coatings of calendared PVC sandwiching a middle layer of polyester woven mesh fabric for strength. More often than not, existing banners are inconsistent in performance quality, and come with substantial amounts of heavy metal and other prohibited heavy metal components in the largely unregulated markets. The PVC is typically heavily plasticized leading to concerns about the plasticizer composition and contamination of the plasticizer onto other substrates. Also PVC processing, usage, and disposal pose potential biological hazards due to dioxin emission, presence of halogens, usage of carcinogenic vinyl chloride monomer, etc.

There is a strong rationale to design a differentiated product replacing the presently ubiquitous printing media, at a price point similar to that of products already existing in this category. Increased focus on non-PVC products and specification driven businesses is the trend for the market, thus providing significant addressable opportunities. Tier C banners are the single largest product category for signages in commercial graphics industry. There is a pressing need to come up with differentiated products at the correct price points to meet Tier C requirements.

Specifically, there are three key drawbacks associated with the existing products namely the printable layer is made up of PVC which has been losing acceptance in the marketplace due to environmental concerns; the existing PVC based banners show a “mesh” like impression on surface; and, in cases where a PVC-free printable layer is used, the PVC-free printable layer does not adhere to the polyester nonwoven substrate without either the use of an adhesive or tie layer, or pre-treatment of substrate such as corona treatment.

In other cases, where a printable composition is solution coated on to the nonwoven, the solution penetrates through the porous nonwoven media thereby adversely affecting its mechanical properties.

Several attempts have been made in the past to overcome the drawbacks presented in the prior art, the majority of which use blends of polymers other than PVC in the printable compositions with or without a substrate, or by extrusion coating of polymers or blends of polymers on a substrate such as paper or aluminum foil, to form an extrusion coated substrate.

U.S. Pat. No. 6,316,120 discloses an image receptor medium made of only nonhalogenated polymers comprising an image reception layer having two major opposing surfaces, wherein the image reception layer comprises an ethylene vinyl acetate carbon monoxide terpolymer, and an adhesive layer on the outer surface which is not associated with the substrate layer. The composition disclosed in the document requires an additional adhesive layer to be bound to the substrate, which makes the printable medium to become more complex in nature. The adhesive disclosed herein appears to be used for calendered/cast polymer films but not for non-woven substrates.

EP2144221 discloses a biodegradable film for advertisement. The films to which the biodegradable polymer is applied as a cover layer are solvent inks or bio inks and are used as materials for indoor or outdoor advertisement, such as banners and flexes. The biodegradable cover layer used in the film is not suitable for digital printing, and also the construction consists of an additional fabric and adhesive layers, which makes the manufacturing process multistage and hence, more complicated and cost intensive.

JP2004314594 discloses an ink jet recording sheet with the support, a primer layer which is applied on one face side of the support and has solvent resistance, and the ink receiving layer formed on the upper face of the primer layer. The invention involves coating of the base material with a tie layer onto which an ink receptive coating is applied. The process disclosed involves multiple steps which are difficult to practice at large scale.

US Pat. Pub. No. 2006154003 discloses multilayer structure for banners which has substrate layer, intermediate layer of ethylene copolymer having specific thickness, and outer layer of thermoplastic polymer having specific moisture vapor transmission rate and thickness. The outer layer is thermoplastic elastomeric ester ether containing soft segments derived from polyalkylene ether glycol. The polyalkylene ether glycol is a copolymer of ethylene oxide and propylene oxide. The intermediate layer contains copolymer of ethylene-vinyl acetate and ethylene-alkyl (meth)acrylate, which is chosen from ethylene-methyl acrylate copolymer, ethylene-butyl acrylate copolymer and ethylene-ethyl acrylate. This is a very water permeable layer for the waterbased ink jet inks to be absorbed and then dry. They need a moisture impermeable layer under that to hold the waterbased ink jet inks on the surface in their receptor layer.

US Pat. Pub. No. 20070110925 discloses a graphic substrate comprising a core layer having opposed front and back sides, and a polymeric top layer bonded to the front side of the core layer. The top layer defines a front face which is receptive to solvent-based inks.

The top layer and the core layer are adapted to be recycled without first being separated. The substrate may be carried on a support to provide a graphics display. This document does not disclose the use of a non-woven substrate as the base layer and also does not specify an optimum ink-receptive non PVC coating formulation

WO201062939 discloses a recyclable coated banner substrate comprising a composition affixed to the planar polyolefin banner substrate. The composition comprises a copolymer (a) and ethylene copolymer (b). The copolymer (a) is obtained from copolymerization of ethylene and maleic anhydride or its functional equivalent. The ethylene copolymer (b) is obtained from copolymerization of ethylene with polar monomer. The copolymer (b) is chosen from ethylene/vinyl acetate copolymer, ethylene/alkyl(meth)acrylate copolymer and ethylene/(meth)acrylate/carbon monoxide terpolymer. The substrate selected for preparing the printable medium disclosed in the document is a polyolefin. Polyolefins have few major disadvantages:

a) it is not as strong as s PET in general, b) lower temperature stability especially as it relates to processing (either post processing) while passing through certain printers which have higher temperature, and c) poor resistance to outdoor environment e.g. UV stability etc.

WO2011153296 discloses Ink/dye receptive substrate coated with an acrylate polymer using solution coating. The acrylate polymer comprises repeating units of at least one 4 to 30 carbon unsaturated aliphatic olefin monomer, repeating units of at least one acrylate monomer, and optionally, repeating units of at least one additional ethylenically unsaturated monomer, which comprises unsaturated carboxylic acids, methacrylate monomers, unsaturated nitrile group containing monomers or vinyl monomers. Solution coating of substrate adversely affects the nonwoven web's mechanical properties, and hence is not desirable.

The polymer blends used in the prior art references to prepare the printable compositions/medium did not provide satisfactory coating or printing performance on various printing platforms. These coating compositions when applied to substrates resulted in poor barrier properties and poor strength. Also the polymer blends required additional adhesives layer in order to be applied to the substrate.

Hence, there remains a need to provide a non-PVC printable media and a single stage process for its preparation that is highly efficient and simple from a manufacturing viewpoint and that provides enhanced adhesion without the use of an additional adhesive layer.

### SUMMARY OF THE INVENTION

The present invention provides a cost effective non-PVC printable nonwoven media which can be prepared in a single step without any pre-treatment of the nonwoven substrate while maintaining the web's mechanical properties. The present invention solves the problems existing in the prior art by describing a method of coating a unique composition on to an untreated polymer substrate wherein the coated layer shows excellent ink receptivity, bonds directly to the nonwoven layer without any material or processing aid, and does not adversely affect the nonwoven's mechanical properties.

The present invention relates to a self adhering printable composition for digital printing, and a printable media prepared by coating of the printable composition on an untreated nonwoven substrate, wherein the printable composition comprises:

a) an ethylene vinyl acetate carbon monoxide terpolymeric resin component,
b) an ethylene copolymer resin component, and
c) a filler.

Another aspect of the present invention provides a process for the preparation of a printable media comprising the steps of:

Coating of a printable composition comprising
a) an ethylene vinyl acetate carbon monoxide terpolymeric resin component,
b) an ethylene copolymer resin component, and
c) a filler.
on a substrate, wherein the substrate is non-woven.

Further scope and applicability of the present invention will become apparent from the detailed description given hereinafter. However, it should be understood that the detailed description and specific examples, while indicating embodiments of the invention, are given by way of illustration only, because various changes and modifications within the spirit and scope of the invention will become apparent to those skilled in the art from this detailed description. It is to be understood that both the foregoing general description and the following detailed description are exemplary and explanatory only and are not restrictive of the invention, as claimed.

### BRIEF DESCRIPTION OF DRAWINGS

The following detailed description of the invention will be better understood when read in conjunction with the appended drawings. For the purpose of assisting in the explanation of the invention, there are shown in the drawings embodiments which are presently preferred and considered illustrative. It should be understood, however, that the invention is not limited to the precise arrangements and instrumentalities shown therein.

FIG. 1 is a schematic diagram of the coating process of the present invention as exemplified in Example 1.

FIG. 2 is a schematic representation of the die design as used for tear strength of the printed samples as exemplified in Example 3.

FIG. 3 is the graphical representation of the comparison of tear strength with existing PVC signage as exemplified in Example 3

### DETAILED DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification are to be understood as being modified in all instances by the term “about”. It is noted that, unless otherwise stated, all percentages given in this specification and appended claims refer to percentages by weight of the total composition.

Thus, before describing the present invention in detail, it is to be understood that this invention is not limited to particularly exemplified systems or process parameters that may of course, vary. It is also to be understood that the terminology used herein is for the purpose of describing particular embodiments of the invention only, and is not intended to limit the scope of the invention in any manner.

The use of examples anywhere in this specification including examples of any terms discussed herein is illustrative only, and in no way limits the scope and meaning of the invention or of any exemplified term. Likewise, the invention is not limited to various embodiments given in this specification.

Unless otherwise defined, all technical and scientific terms used herein have the same meaning as commonly understood by one of ordinary skill in the art to which this invention pertains. In the case of conflict, the present document, including definitions will control.

It must be noted that, as used in this specification and the appended claims, the singular forms “a,” “an” and “the” include plural referents unless the content clearly dictates otherwise. Thus, for example, reference to a “polymer” may include two or more such polymers.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the terms “comprising” “including,” “having,” “containing,” “involving,” and the like are to be understood to be open-ended, i.e., to mean including but not limited to.

As used herein, the term “self adhering” intends to mean that the material can be adhered or bonded to a substrate without the need for another component.

As used herein, the term “digital printing” intends to mean methods of printing from a digital-based image directly to a variety of media. It usually refers to professional printing where jobs from desktop publishing and other digital sources are printed using large-format and/or high-volume laser or inkjet printers, including solvent printers, eco solvent printers, latex printers and UV printers etc.

As used herein, the term “ink jet printing” refers to the well known process of depositing liquids using ink-jet architecture, and is in no way limited to depositing inks or ink-containing compositions. Thus, although some embodiments of the present invention may include various inks, i.e. the presence of a colorant, this is not required. Similarly, ink-jetting of materials “on” a substrate can include direct contact of such material with the substrate or can indicate that the material is printed in contact with a separate material or layer which is in direct or indirect contact with the substrate.

As used herein, the term “extrusion coating” intends to mean coating of a molten web of synthetic composition on to a substrate material. It is a versatile coating technique used for the economic application of various plastics, notably polyethylene, onto paperboard, corrugated fiberboard, paper, aluminium foils, cellulose or plastic films.

The actual process of extrusion coating involves extruding a composition to be coated from a slit die at temperatures up to 300° C. directly onto the moving web which is then passed through a nip consisting of a rubber covered pressure roller and a chrome plated cooling roll. The latter cools the molten film back into the solid state and also imparts the desired finish to the surface of the coated substrate.

As used herein, the term “signages” or “signage” or “signs” are any kind of visual graphics created to display information to a particular audience. This is typically manifested in the form of way finding information in places such as streets or inside/outside of buildings. Signs, however, are best known in the form of painted or carved, printed or electro-cut advertisements for shops, inns, etc. They are one of various emblematic methods used from time immemorial for publicly calling attention to the place to which they refer.

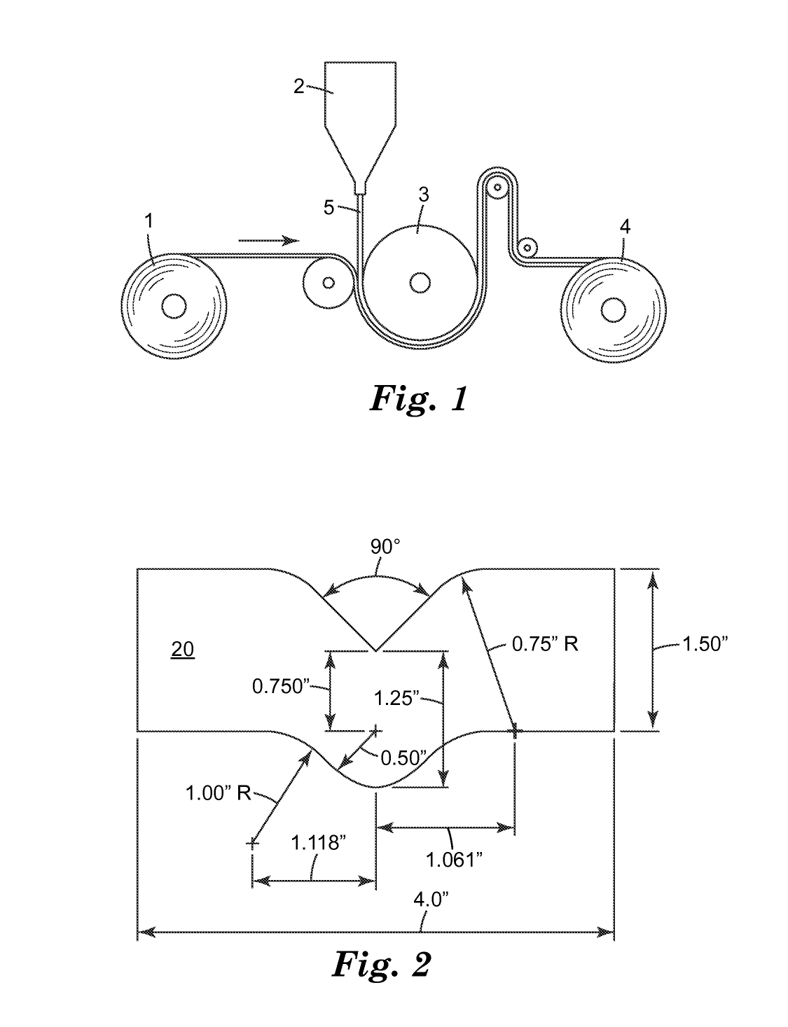

FIG. 1 is a schematic diagram of the coating process of a primary web 1 according to the present disclosure as exemplified in Example 1. A mix of pellets, including resins and fillers, is fed into extruder 2, which extrudes extrudate film 5 on top of the primary web 1. The extrudate film 5 is cooled by the chill roller 3, and subsequently wound as a finished web 4.

The present invention relates to a printable composition for digital printing, and a printable media prepared by coating of the printable composition on an untreated nonwoven substrate wherein the printable composition comprises of:

a) an ethylene vinyl acetate carbon monoxide terpolymeric resin component,
b) an ethylene copolymer resin component, and
c) a filler.

The ethylene vinyl acetate carbon monoxide terpolymer for use in the present invention may contain about 70 wt % of an ethylene-vinyl acetate copolymer having a vinyl acetate percentage of about 40 and a melt flow index (MFI) of about 3; and about 30 wt % of an ethylene-vinyl acetate-carbon monoxide terpolymer having a vinyl acetate percentage of about 24; a carbon monoxide percentage of about 8-12 and a MFI of about 35 or from about 50-95 wt % of an ethylene-vinyl acetate copolymer having a vinyl acetate percentage of about 18-60 wt % and a melt flow index (MFI) of <1 to about 100 decigrams/10 min; and 5-50 wt % of an ethylene-vinyl acetate-carbon monoxide terpolymer having a vinyl acetate percentage of 18-35 wt %; a CO percentage of 3-20 wt % and a melt flow index (MFI) of 5 to about 100 decigrams/10 min.

In an embodiment, the ethylene vinyl acetate carbon monoxide terpolymer contains ethylene vinyl acetate copolymer having a vinyl acetate content of 28 to 46 wt % and an MFI of 1 to 10 and an ethylene vinyl acetate carbon monoxide terpolymer having a vinyl acetate percentage of 20-30 wt %; a carbon monoxide percentage of 8-12 wt % and an MFI of 20-50.

The amount of the three monomers in the terpolymer can range from about 50% to 80% or from 65% to 75% weight percent of ethylene monomer, about 10% to 30% or from 20% to 24% weight percent of vinyl acetate monomer, and about 4% to 15% or from 8% to 10% of carbon monoxide monomer.

The ethylene vinyl acetate carbon monoxide terpolymer is commercially available from such sources as DuPont of Wilmington, Del., USA under the Brand™ resin. These resins provide excellent ink receptivity to inks usually intended to bond to PVC without the requirement of any further treatment. The percentage of this resin component in the composition may range from about 10 to about 50% or from about 10 to about 30% by weight to the weight of the total composition.

The use of the ethylene vinyl acetate carbon monoxide terpolymer provides excellent adhesion to untreated polypropelyne, polyesters, biodegradable Polylactic acid etc non-wovens made through a variety of processes without significantly reducing tear properties of the extrusion coated final construction.

The acrylate resins which can be used in the present invention include, but are not limited to ethylene (meth)acrylic acid copolymers, ethylene (meth)acrylic acid n-butyl (meth)acrylate copolymers, ethylene (meth)acrylic acid iso-butyl (meth)acrylate copolymers, ethylene (meth)acrylic acid tort-butyl (meth)acrylate copolymers, ethylene (meth)acrylic acid methyl (meth) acrylate copolymers, ethylene (meth)acrylic acid ethyl (meth)acrylate copolymers, ethylene maleic acid monoester n-butyl (meth)acrylate copolymers, ethylene maleic acid monoester methyl (meth)acrylate copolymers, ethylene maleic acid monoester ethyl (meth)acrylate copolymers, or combinations of two or more thereof.

The acrylate resins control the spread of solvent based ink jet drops, the ethylene copolymer resin modifies the viscosity of the resultant blend aiding in processing and reducing the tackiness and blocking of the ethylene/vinyl acetate/carbon monoxide terpolymer resin. Modified viscosity improves manufacturing operations, especially extrusion manufacturing for making receptor media of the present invention. The percentage of the acrylate resin component in the composition may range from about 50 to about 80% or from about 60 to about 70% by weight to the weight of the total composition.

Commercially available modified ethylene vinyl acetate, carbon monoxide resins that are useful for the composition of the present invention include various types of ethylene vinyl acetate carbon monoxide terpolymers and a blend of ethylene copolymer resins, such as ELVALOY 741, a terpolymer of ethylene/vinyl acetate/carbon monoxide; ELVALOY 4924, a terpolymer of ethylene/vinyl acetate/carbon monoxide; and ELVALOY 1218A, and commercially available acrylate resins include, 3101, BYNEL 3101M, which is an acid-acrylate modified ethylene vinyl acetate copolymer, or Chevron SP 1305 ethylene methyl acrylate resin.

Elvaloy 741 (ethylene/vinyl acetate/carbon monoxide terpolymer) bonds well to the substrate without any pretreatment or priming through the novel application of extrusion coating. The Elvaloy also provides good anchorage of graphic inks without requiring treatment of the extruded non-PVC receptor layer.

In an embodiment, the gloss enhancers which can be used for the present invention can be ethylene copolymers selected from Dupont Surlyn 1705-1.

Another component of an ink-receptive according to the present invention is one or more particulate fillers or pigments, which increase the opacity and/or modify the porosity of the coated substrate. Nonlimiting examples for fillers include silica (preferably, amorphous silica gels and/or colloidal silica), silicic acid, clays, zeolites, alumina, TiO₂, M_{g}CO₃ and the like. The percentage of filler in the composition may range from about 0 to about 50% by weight to the weight of the total composition.

In an embodiment, the filler used in the present invention is TiO₂ and can be added to the composition of the present invention along with the resin components forming the polymer blend, or may be added during the coating operation. Titanium dioxide additionally imparts UV stability to the printable composition.

In an embodiment, the printable composition of the present invention comprises of, ELVALOY, and TiO₂ in a ration of 60:20:20 by weight.

Stabilizers also can be included in the etchant. Exemplary stabilizers include an ultraviolet light stabilizer and an ultraviolet light absorber.

Further additional components can include UV stabilizers if desired, pigments if desired, processing aids if desired, antiblock agents if desired, and antistatic agent if desired.

The present invention provides a printable composition having good coatability and a good bonding between the substrate and the coating. These compositions provide a coating composition that has excellent adhesion to the substrate as well as other desirable properties. Thin coatings have, in addition to other desirable properties, good bonding properties, good barrier properties and good adhesion retention characteristics.

The substrate onto which the printable composition is coated comprises at least one structure-providing component or substrate, which provides additional physical integrity and form. The nature of the substrate is dependent on one or more of an intended use of the sign, the nature of the ink-receiving material, the designed tear strength, the designed tensile strength, the designed surface texture and the designed longevity. The substrates of the support may be fabricated from, for example, polyolefins, polyesters, polyurethanes, polyvinyl chlorides, polyamides, polystyrene, ethylene vinyl alcohol, polylactic acid, and cellulose and combinations of two or more of the above.

The substrate may be in the form of an extruded film or layer, or a woven or a non-woven scrim. One or more of the substrates of the present may be fabricated from polyethylene (PE), polypropylene (PP), polyethylene terephthalate (PET), Polylactic Acids (PLA), ethylene vinyl acetate (EVA), polystyrene (PS), polycarbonate, and polyamide polymer and combinations of two or more of the above. The thickness of the substrate depends on one or more of the physical form of the substrate (e.g., extruded layer, extruded film, woven scrim, or non-woven scrim), the nature of the function of the substrate (for example, provide one or more of stiffness (rigidity), tear and tensile strength, opacity, longevity, and ability to be recycled), the nature of the ink-receiving material, the nature of the material with which the substrate is associated, for example.

The basis weight of the substrate in the form of an extruded layer or extruded film, or woven scrim, or non-woven scrim may range from about 50 GSM-500 GSM, considering an optimal combination of tear strength, tensile strength, flexibility & cost.

In an embodiment, the nonwoven substrate can be made of a polyester or PLA (Poly Lactic Acid), in which case, the final two-layer structure is an ideal sustainable product offering PLA being a biopolymer derived from a green source (corn).

Another aspect of the present invention provides a process for the preparation of the PVC-free printable media comprising the steps of:

coating of a printable composition comprising
a) an ethylene vinyl acetate carbon monoxide terpolymeric resin component,
b) an ethylene copolymer resin component, and
c) a filler.
on a substrate wherein the substrate is a non woven substrate.

Printable medium of the present invention is formed by co-, hot melt, cast process, modification of cast or operation, lamination, blown process, film, or sheet. The system may comprise, by way of illustration and not limitation, a vertical single screw extruder or a horizontal single screw extruder. The coating of the printable composition may be formed on the substrate by an process where the substrate is assembled either prior to or during the process. The printable composition is heated to a predetermined temperature of the range of 100 to 300° C. or from about 150 to 250° C., which is a temperature at, or above, the processing temperature or melting temperature of the extruded materials, and then deposited on a moving substrate at a substantially uniform thickness.

In an embodiment, the medium is formed by extrusion coating of the printable composition of the present invention of a polyester substrate wherein the temperature and speed employed in the process are adjusted based on the nature of the substrate or of other components of the substrate, and the nature of the extruder.

Suitable temperatures for the extrusion coating process may range from about 100 to about 300° C. or from about 150 to about 300° C.

The uniqueness of the invention is that the printable composition is coated on to a polyester nonwoven substrate without the aid of any adhesive, tie layer or pre-treatment of the nonwoven web while simultaneously achieving excellent printability of the final composition.

The thickness of the coating on the substrate may range from about 10 to about 500 microns, or from about 10 to about 200 microns, or about 10 to about 100 microns, or about 50 to about 100 microns.

The printable medium of the present invention can be used for printing on diverse digital printing platforms and can be a prepared in a low-cost single step process. They are ideally suited for various outdoor and indoor banner applications. They are both cheaper and lighter than their textile counterparts which make them highly attractive for such applications.

The present ink—may be employed as printing media where they are particularly adapted for use with inkjet ink. Such include, for example, solvent inkjet ink, eco solvent inkjet ink, latex inkjet ink and UV-curable inkjet inks, and combinations thereof. Examples of the present ink—can be printed at a broad range of printing parameters depending on, for example, the nature of the printing apparatus.

The following examples are provided to better illustrate the claimed invention and are not to be interpreted in any way as limiting the scope of the invention. All specific materials, and methods described below, fall within the scope of the invention. These specific compositions, materials, and methods are not intended to limit the invention, but merely to illustrate specific embodiments falling within the scope of the invention. One skilled in the art may develop equivalent materials, and methods without the exercise of inventive capacity and without departing from the scope of the invention. It is the intention of the inventors that such variations are included within the scope of the invention

### EXAMPLES

### Example 1

### Preparation of the Print Media and Coating the Medium on to a Non-Woven Substrate

A mixture of DuPont Bynel 3101/DuPont Elvaloy 741/Standridge 11937 TiO2 concentrate at a ratio of 60/20/20 by weight percent were blended together in a one gallon plastic bag and the resins were macro-mixed until the pellets appeared uniformly distributed.

The resin pellets were fed into a 1.9 cm (¾ in) single screw extruder manufactured by C. W. Brabender Instruments Inc., South Hackensack, N.J., 07606, with a temperature profile from 204° C. to 232° C. resulting in a melt temperature of about 232° C. A horizontal die was used to cast the films onto a nonwoven web approximately 15 cm wide with a basis weight of 40 to 60 GSM traveling at approximately 3 meters/min (10 ft/min.). The resulting film construction was run between a steel chill roll and a rubber backup roll to solidify the molten resin into a layer having a thickness of approximately 0.1 mm (0.004 in). The resultant extrusion coated nonwoven showed very good adhesion of the extrudate to the nonwoven and the nonwoven web retains the bulk of its physical strength and tear properties.

### Example 2

### Printing of Extrusion Coated Samples

The invented non-woven banner was printed on a Vutek 150 with 1500v2 inks on a profile standard for PVC banners. The print quality was inspected visually, and received a satisfactory score on accounts of ink adhesion, dot gain and color consistency.

### Example 3

### Comparison of Tear Strength

The tear strength were measured based on ASTM D1004 on an Instron UTM. The samples measured were prepared as per the die size displayed in FIG. 2 The samples were cut on the die by hammering through a mallet hammer. The conditioned samples (23 C & 50% RH for 40 Hours) are then measured for tear strength values through a standard tensile test on the UTM with an initial jaw separation of 25.4 mm and the rate of travel of the power activated grip 51 mm/min.

FIG. 2 is a schematic representation of die design 20 as used to cut samples used in the tear strength tests referenced above. A sample is cut according to the template of the die design and tested for tear strength.

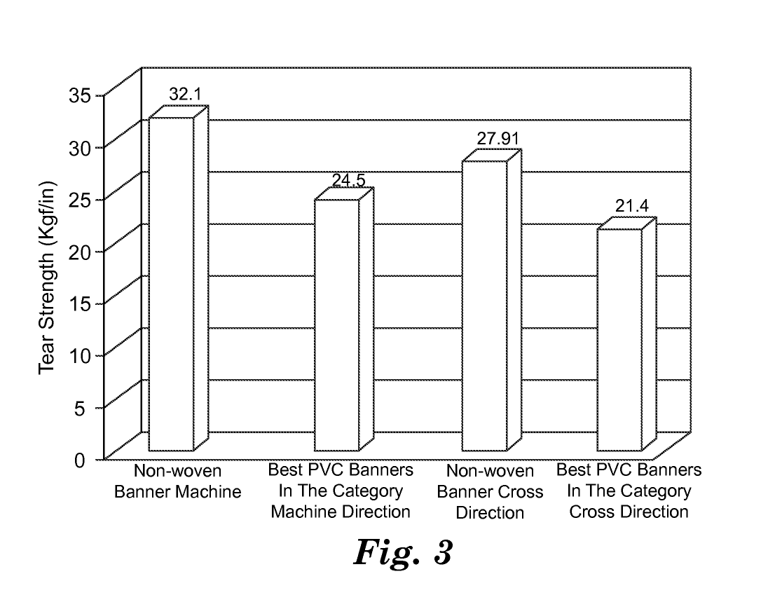

The tear strength results have been provided in FIG. 3. The results indicate that the non-wovens could be designed to have higher tear strength for similar densities as compared to existing PVC based banners.

The comparative experiment enabled to benchmark the product against existing products with similar intended applications. This experiment indicates that the invention would have suitable strength and durability for such applications on the field.

The product has been tested in the field for handling and mounting on sign boxes of sizes 8 ft by 4 ft and found to withstand the tensioning force.

1. A printable medium containing a self-adhering printable composition on an untreated nonwoven substrate, wherein the printable composition comprises of:
a) an ethylene vinyl acetate carbon monoxide terpolymeric resin component,
b) an ethylene copolymer resin component, and
c) a filler.

2. The printable medium as claimed in claim 1, wherein the nonwoven substrate is a polyester or poly lactic acid

3. The printable medium as claimed in claim 1, wherein the ethylene vinyl acetate carbon monoxide terpolymer contains ethylene vinyl acetate copolymer having a vinyl acetate content of 28 to 46 wt % and an melt flow index (MFI) of 1 to 10 and an ethylene vinyl acetate carbon monoxide terpolymer having a vinyl acetate percentage of 20-30 wt %; a carbon monoxide percentage of 8-12 wt % and an WI of 20-50.

4. The printable medium as claimed in claim 1, wherein percentage of the ethylene vinyl acetate carbon monoxide resin component in the composition ranges between 10 to 30% by weight to the weight of the total composition.

5. The printable medium as claimed in claim 1, wherein the ethylene copolymer resin component is an acid-acrylate modified ethylene vinyl acetate copolymer.

6. The printable medium as claimed in claim 1, wherein percentage of the ethylene copolymer resin component in the composition ranges between 60 to 80% by weight to the weight of the total composition.

7. The printable medium as claimed in claim 1, wherein the filler is selected from silica, silicic acid, clays, zeolites, alumina, TiO₂, and M_{g}CO₃.

8. The printable medium as claimed in claim 1, wherein the filler is TiO₂.

9. The printable medium as claimed in claim 1, wherein percentage of the filler in the composition ranges between 10 to 20% by weight to the weight of the total composition.

10. The printable media as claimed in claim 1, wherein the ratio of the ethylene copolymer resin component, ethylene vinyl acetate carbon monoxide terpolymer, and the filler is 60:20:20 by weight.

11. The printable medium as claimed in claim 1, wherein the composition comprises of a gloss enhancer.

12. The printable medium as claimed in claim 11, wherein the gloss enhancer is a zinc ionomer.

13. A process for the preparation of the PVC-free printable media comprising coating of
a printable composition comprising
an ethylene vinyl acetate carbon monoxide terpolymeric resin component,
an ethylene copolymer resin component, and
a filler,
on an untreated substrate wherein the substrate is a nonwoven substrate.

14. The process as claimed in claim 13, wherein the coating is an extrusion coating.

15. The process as claimed in claim 13, wherein the thickness of the coating may range from about 10 to about 500 microns, or from about 10 to about 200 microns, or about 10 to about 100 microns, or about 50 to about 100 microns.

16. The process as claimed in claim 13, wherein the basis weight of the substrate may range from about 50 GSM-500 GSM

17. The process as claimed in claim 13, wherein the extrusion coating is carried out at temperatures of about 150 to about 300° C.
